(19) United States
(12) Patent Application Publication
(10) Pub. No.: US 2024/0013558 A1
(43) Pub. Date: Jan. 11, 2024

(54) CROSS-MODAL FEATURE EXTRACTION, RETRIEVAL, AND MODEL TRAINING METHOD AND APPARATUS, AND MEDIUM

(71) Applicant: BEIJING BAIDU NETCOM SCIENCE TECHNOLOGY CO., LTD., Beijing (CN)

(72) Inventors: Haoran WANG, Beijing (CN); Dongliang HE, Beijing (CN); Fu LI, Beijing (CN); Errui DING, Beijing (CN)

(73) Assignee: BEIJING BAIDU NETCOM SCIENCE TECHNOLOGY CO., LTD., Beijing (CN)

(21) Appl. No.: 18/113,266

(22) Filed: Feb. 23, 2023

(30) Foreign Application Priority Data
Jul. 7, 2022 (CN) 202210803045.7

(51) Int. Cl. G06V 20/70; G06V 10/774; G06V 20/40; G06F 40/30; G06F 40/279

(52) U.S. Cl. CPC G06V 20/70; G06V 10/774; G06V 20/46; G06F 40/30; G06F 40/279

(57) ABSTRACT

There is provided cross-modal feature extraction, retrieval, and model training methods and apparatuses, and a medium, which relates to the field of artificial intelligence (AI) technologies, and specifically to fields of deep learning, image processing, and computer vision technologies. A specific implementation solution involves: acquiring to-be-processed data, the to-be-processed data corresponding to at least two types of first modalities; determining first data of a second modality in the to-be-processed data, the second modality being any of the types of the first modalities; performing semantic entity extraction on the first data to obtain semantic entities; and acquiring semantic coding features of the first data based on the first data and the semantic entities and by using a pre-trained cross-modal feature extraction model.

### CROSS-REFERENCE TO RELATED APPLICATIONS

The present application claims the priority of Chinese Patent Application No. 202210803045.7, filed on Jul. 7, 2022, with the title of “CROSS-MODAL FEATURE EXTRACTION, RETRIEVAL, AND MODEL TRAINING METHOD AND APPARATUS, AND MEDIUM.” The disclosure of the above application is incorporated herein by reference in its entirety.

### FIELD OF THE DISCLOSURE

The present disclosure relates to the field of artificial intelligence (AI) technologies, specifically to fields of deep learning, image processing, and computer vision technologies, and in particular, to cross-modal feature extraction, retrieval, and model training methods and apparatuses, and a medium.

### BACKGROUND OF THE DISCLOSURE

In recent years, short video applications have attracted a large portion of Internet traffic. On the one hand, this phenomenon leads to generation of a large amount of video content over the Internet and accumulation of a large amount of data. On the other hand, how to retrieve corresponding content required by users from massive video and how to identify video content produced by users to enable such content to be better used subsequently to obtain more accurate traffic increase and content classification management, etc. put forward new requirements for video understanding and cross-modal retrieval technologies in the video field.

In cross-modal retrieval solutions based on video and text, features of the video and features of the corresponding text are required to be acquired respectively, so as to realize cross-modal retrieval. The features of the video are implemented based on a method of video feature fusion. For example, firstly, different types of features of the video may be extracted, such as audio, automatic speech recognition (ASR) text, object detection, and action recognition features. Each type of features is extracted by using a dedicated feature extractor. Next, global features of the video are obtained by fusing a plurality of types of features. At the same time, the features of the text are extracted by using a dedicated encoder. Finally, semantic feature alignment is performed in a public global semantic space to obtain a cross-modal semantic similarity, thereby realizing retrieval.

### SUMMARY OF THE DISCLOSURE

The present disclosure provides cross-modal feature extraction, retrieval, and model training methods and apparatuses, and a medium.

According to an aspect of the present disclosure, a method for feature extraction in cross-modal applications is provided, including acquiring to-be-processed data, the to-be-processed data corresponding to at least two types of first modalities; determining first data of a second modality in the to-be-processed data, the second modality being any of the types of the first modalities; performing semantic entity extraction on the first data to obtain semantic entities; and acquiring semantic coding features of the first data based on the first data and the semantic entities and by using a pre-trained cross-modal feature extraction model.

According to another aspect of the present disclosure, a method for cross-modal retrieval is provided, including performing semantic entity extraction on query information to obtain at least two first semantic entities; the query information corresponding to a first modality; acquiring first information of a second modality of data from a database; the second modality being different from the first modality; and performing cross-modal retrieval in the database based on the query information, the first semantic entities, the first information, and a pre-trained cross-modal feature extraction model to obtain retrieval result information corresponding to the query information, the retrieval result information corresponding to the second modality.

According to yet another aspect of the present disclosure, a method for training a cross-modal feature extraction model is provided, including acquiring a training data set including at least two pieces of training data, the training data corresponding to at least two types of first modalities; determining first data of a second modality and second data of a third modality in the training data set, the second modality and the third modality each being any of the types of the first modalities; and the second modality being different from the third modality; performing semantic entity extraction on the first data and the second data respectively to obtain at least two first training semantic entities and at least two second training semantic entities; and training a cross-modal feature extraction model based on the first data, the at least two first training semantic entities, the second data, and the at least two second training semantic entities.

According to still another aspect of the present disclosure, there is provided an electronic device, including at least one processor; and a memory communicatively connected with the at least one processor; wherein the memory stores instructions executable by the at least one processor, and the instructions are executed by the at least one processor to enable the at least one processor to perform a method for feature extraction in cross-modal applications, wherein the method includes acquiring to-be-processed data, the to-be-processed data corresponding to at least two types of first modalities; determining first data of a second modality in the to-be-processed data, the second modality being any of the types of the first modalities; performing semantic entity extraction on the first data to obtain semantic entities; and acquiring semantic coding features of the first data based on the first data and the semantic entities and by using a pre-trained cross-modal feature extraction model.

According to another aspect of the present disclosure, there is provided a non-transitory computer readable storage medium with computer instructions stored thereon, wherein the computer instructions are used for causing a method for feature extraction in cross-modal applications, wherein the method includes acquiring to-be-processed data, the to-be-processed data corresponding to at least two types of first modalities; determining first data of a second modality in the to-be-processed data, the second modality being any of the types of the first modalities; performing semantic entity extraction on the first data to obtain semantic entities; and acquiring semantic coding features of the first data based on the first data and the semantic entities and by using a pre-trained cross-modal feature extraction model.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure;

FIG. 7 is a training architecture diagram of a cross-modal feature extraction model based on video and text according to the present disclosure;

FIG. 8 is a schematic diagram according to a seventh embodiment of the present disclosure;

FIG. 9 is a schematic diagram according to an eighth embodiment of the present disclosure;

FIG. 10 is a schematic diagram according to a ninth embodiment of the present disclosure;

FIG. 11 is a schematic diagram according to a tenth embodiment of the present disclosure;

FIG. 12 is a block diagram of an electronic device configured to implement a method according to an embodiment of the present disclosure; and

FIG. 13 shows formulas described in the present disclosure.

### DETAILED DESCRIPTION OF PREFERRED EMBODIMENTS

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, personal digital assistants (PDAs), wireless handheld devices, and tablet computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

However, in cross-modal retrieval based on video and text in the prior art, corresponding types of features in the video are extracted by using different types of feature extractors, and then are fused to obtain global features of the video. For the text, features of the text are also extracted by using a pre-trained encoder. In the feature extraction processes, the features of the whole video or text are extracted without considering finer-grained information under corresponding modalities, resulting in poor accuracy of the features obtained.

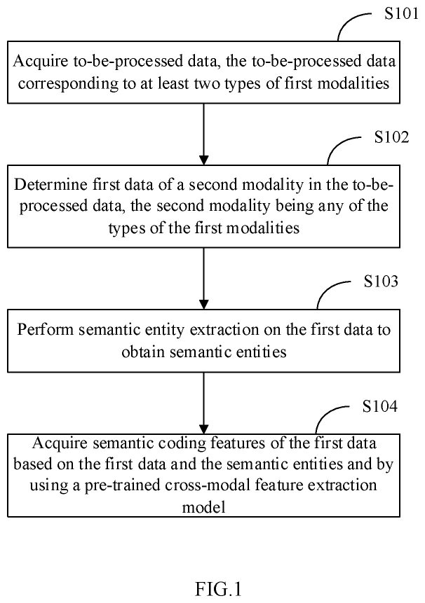

FIG. 1 is a schematic diagram according to a first embodiment of the present disclosure. As shown in FIG. 1, this embodiment provides a method for feature extraction in cross-modal applications, which, for example, may be applied to cross-modal retrieval to extract features of each modality. The method may specifically include the following steps.

In S101, to-be-processed data is acquired, the to-be-processed data corresponding to at least two types of first modalities.

In S102, first data of a second modality is determined in the to-be-processed data, the second modality being any of the types of the first modalities.

In S103, semantic entity extraction is performed on the first data to obtain semantic entities.

In S104, semantic coding features of the first data are acquired based on the first data and the semantic entities and by using a pre-trained cross-modal feature extraction model.

The to-be-processed data in this embodiment may involve at least two types of first modalities. For example, a video modality and a text modality may be included in a cross-modal scenario based on video and text. Optionally, in practical applications, it may also be extended to include information of other modalities such as a voice modality, which is not limited herein.

In this embodiment, semantic entity extraction may be performed on the first data to obtain semantic entities, and a number of the semantic entities may be one, two or more. The semantic entities are some fine-grained information in the second modality, and can also represent information of the second modality of the first data to some extent.

In this embodiment, for the first data of each second modality of the to-be-processed data, the first data and the semantic entities included in the first data may be referred to, and the semantic coding features corresponding to the first data may be extracted by using the pre-trained cross-modal feature extraction model. During extraction of the coding features, due to the reference to the fine-grained information of the first data of the second modality, such as the semantic entities, accuracy of the obtained semantic coding features can be improved.

According to the method for feature extraction in cross-modal applications in this embodiment, the semantic coding features can be extracted together with the first data with reference to the fine-grained information of the first data of the second modality, such as the semantic entities. Due to the reference to the fine-grained information, accuracy of the semantic coding features corresponding to the obtained data of the modality can be effectively improved.

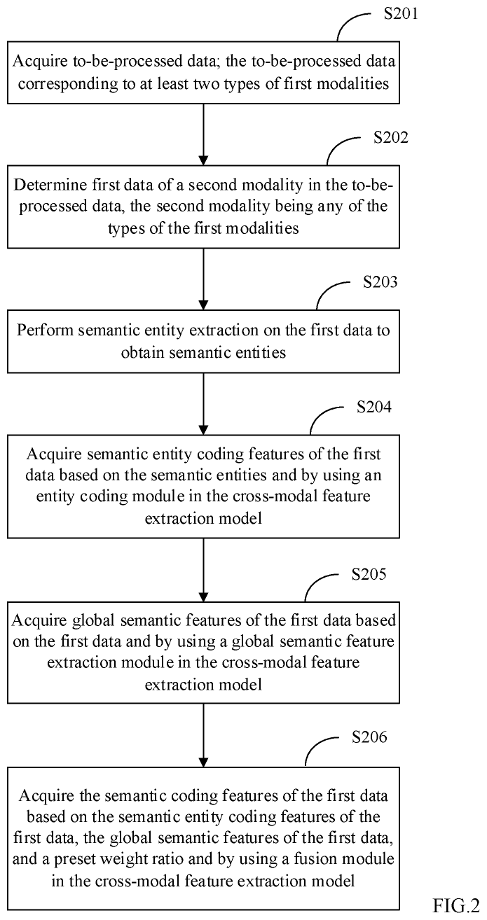

FIG. 2 is a schematic diagram according to a second embodiment of the present disclosure. This embodiment provides a method for feature extraction in cross-modal applications, and describes the technical solution of the present disclosure in further detail on the basis of the technical solution in the embodiment shown in FIG. 1. As shown in FIG. 2, the method for feature extraction in cross-modal applications according to this embodiment may specifically include the following steps.

In S201, to-be-processed data is acquired, the to-be-processed data corresponding to at least two types of first modalities.

In S202, first data of a second modality is determined in the to-be-processed data, the second modality being any of the types of the first modalities.

In S203, semantic entity extraction is performed on the first data to obtain semantic entities.

For example, in a cross-modal scenario based on video and text, if the second modality is a video modality, that is, the first data is video, the semantic entities of video frames in the first data may be extracted by using a pre-trained semantic entity extraction model to finally obtain a plurality of semantic entities of the first data, i.e., the video.

Specifically, the semantic entities of the video frames in the video may be extracted by using the semantic entity extraction model, and the semantic entities of all the video frames in the video are combined to form the plurality of semantic entities of the video.

The semantic entity extraction model is a bottom-up and top-down combined attention mechanism, implemented through an encoder-decoder framework. In an encoding stage, region of interest (ROI) features of images of the video frames are obtained by using a bottom-up attention mechanism. In a decoding stage, attention is paid to content of the images of the video frames by learning weights of different ROIs, and description is generated word by word.

Firstly, a bottom-up module in the semantic entity extraction model is a pure visual feed-forward network, which uses a faster region-based convolutional neural network (R-CNN) for object detection. The faster R-CNN implements this process in two stages. Firstly, an object proposal is obtained by using a region proposal network (RPN). At the same time, a target boundary and an objectness score are predicted for each position, a top box proposal is selected as input to a second stage by using greedy non-maximum suppression with an intersection over union (IoU) threshold. In the second stage, an ROI pool is configured to extract a small feature map for each box, and then the feature maps are inputted together into a CNN. Final output of the model includes softmax distribution on class labels and class-specific bounding box reconstruction for each box proposal. The bottom-up module is intended mainly to obtain a set of prominent ROI features and their position information in the images, such as bbox coordinates.

The top-down mechanism uses task-specific context, that is, an output sequence obtained by the above bottom-up module, to predict attention distribution on an image region and output obtained text description. In this case, ROI features, bbox coordinates, and text description can be fused together as semantic entities in the video. By processing the video frames in the video in the above manner, a plurality of semantic entities corresponding to the video can be obtained. In this manner, the plurality of semantic entities of the video can be accurately extracted.

If the second modality is a text modality, that is, the first data is text, semantic role labeling (SRL) may be performed on terms of the first data. Then, the semantic entities are acquired based on semantic roles of the terms to finally obtain a plurality of semantic entities corresponding to the text.

Specifically, a syntactic structure of the text and the semantic role of each term can be obtained by performing SRL on a text statement. Then, centering on predicates in a sentence, semantic roles are used to describe a relationship between them, predicate verbs therein are extracted as action entities, and noun entities such as subjects and objects therein may also be extracted. In this manner, the plurality of semantic entities of the text can be accurately extracted.

For example, a sentence “A man is driving” may be labeled as follows: [ARGO: a man] [V: is] [V: Driving], and a noun entity “man” and an action entity “driving” therein can be extracted.

For example, if the second modality is a picture modality, semantic entities of a picture may be extracted with reference to the above entity extraction method for each video frame image. If the second modality is an audio modality, audio may be first recognized as text. Then, corresponding semantic entities may be extracted with reference to the above manner of extracting the semantic entities of the text information.

In S204, semantic entity coding features of the first data are acquired based on the semantic entities and by using an entity coding module in the cross-modal feature extraction model.

For example, during specific implementation, when at least two semantic entities are included, for the first data of the second modality, firstly, coding features of the semantic entities and corresponding attention information may be acquired based on semantic entities of the first data and by using the entity coding module in the cross-modal feature extraction model. Then, the semantic entity coding features of the first data are acquired based on the coding features of the semantic entities and the corresponding attention information. The attention information may specifically be an attention score to reflect a degree of importance of each semantic entity among all the semantic entities of the first data.

In order to make full use of the at least two semantic entities extracted from the first data of the second modality, a self-attention mechanism may be used to allow interaction between different semantic entities corresponding to same modality information to obtain the coding features of the semantic entities, and at the same time, attention scores of the semantic entities and other entities corresponding to the modality information can also be calculated.

For example, during specific implementation, a lookup table may be pre-configured for each semantic entity. The lookup table is similar to a function of a dictionary. When a semantic entity is inputted to the entity coding module, initial code of the semantic entity can be obtained by querying the lookup table. Then, representation of the semantic entity is enhanced by using a Transformer encoder block, so that each entity can interact with other entities to acquire more accurate coding features of each semantic entity. Specifically, a specific calculation process of the Transformer encoder block may be as follows:

$$Attention ( Q , K , V ) = soft max ( \frac{{QK}^{T}}{\sqrt{{d}_{k}}} ) V \qquad ( 1 )$$

$$MultiHead ( Q , K , V ) = Concat ( {head}_{1} , ... , {head}_{n} ) {W}^{O} \qquad ( 2 )$$

$$where {head}_{i} = Attention ( {QW}_{i}^{Q} , {KW}_{i}^{K} , {VW}_{i}^{V} )$$

$$FEN ( x ) = max ( 0 , {xW}_{1} + {b}_{1} ) {W}_{2} + {b}_{2} \qquad ( 3 )$$

It is assumed that a Transformer input vector is X. The formula (1) is a self-attention calculation process, Q corresponds to a query matrix of a current semantic entity, K corresponds to a key matrix of other semantic entities corresponding to information of a same modality, V corresponds to a value matrix of the other semantic entities corresponding to the information of the same modality, and \sqrt{dₖ} denotes a feature dimension. K and V denote different representation matrices of the other semantic entities. Attention weights of the query matrix of the current semantic entity and the key matrix of the other entity semantic entities are obtained through a dot product operation. In order to prevent an excessively low gradient during the training, scaling is performed by being divided by \sqrt{dₖ}, then softmax processing is performed, and the value matrix of the other semantic entities is weighted to obtain enhanced coding features of the current semantic entity, that is, obtain the coding features of the semantic entities. The formula (2) represents a multi-head attention mechanism that uses a plurality of self-attentions during calculation. Wᵢ^{Q}, Wᵢ^{K}, and Wᵢ^{V} respectively denote mapping matrices corresponding to a Q matrix, a K matrix, and a V matrix in an i^{th} head in the multi-head attention mechanism, and W^{O} denotes a mapping matrix that maps concatenated multi-head attention output back to an original dimension of a Transformer Encoder input vector X. The formula (3) is a multilayer perception (MLP) feed-forward neural network, where W₁ and W₂ denote fully connected layer mapping matrices, and b₁ and b₂ denote bias constants.

After entity representation is enhanced by the Transformer encoder block, an attention score, also known as a weight score, may be calculated for each entity to represent its importance to the whole.

There are many semantic entities corresponding to the first data of the second modality, but different semantic entities are of different degrees of importance. For example, in the cross-modal scenario based on video and text, there are many entities in the video and the text and different roles in video content and text sentences. For example, characters are generally more important than background trees, cars are more important than stones on a road, etc. Therefore, there is a need to acquire semantic entity coding features of information of modalities based on the coding features of the semantic entities and the corresponding attention scores. Specifically, the coding features of the semantic entities can be weighted and summed according to the attention scores corresponding to the coding features of the semantic entities to obtain an overall semantic entity coding feature. The coding features of the semantic entities obtained in this manner refer to the coding features and the attention scores of the semantic entities comprehensively, so that the coding features of the semantic entities obtained are more accurate.

In S205, global semantic features of the first data are acquired based on the first data and by using a global semantic feature extraction module in the cross-modal feature extraction model.

Although information of different modalities is heterogeneous in underlying features, the information still has strong correlations in high-level semantics. In order to make high-level feature coding have stronger semantic representation, for example, video frames and text may be encoded by using a contrastive language-image pre-training (CLIP) model in the cross-modal scenario based on video and text. The CLIP model uses 400 million text and picture pairs for contrastive learning and training during the training, and has strong zero-shot capabilities for video image and text coding and cross-modal retrieval. However, video and images have different forms. The video is formed by continuous video frames, which is more sequential than pictures, and this characteristic can often match actions in text. Based on this, in this embodiment, a sequential coding module may be added to the CLIP model to extract sequential features after addition of sequential position code to each video frame. Finally, global semantic features of the video are obtained based on the code of all video frames with sequential relationships.

It is easy to extract global semantic features of the text modality. The whole text is encoded by using the pre-trained semantic representation model, to obtain the corresponding global semantic features.

Extraction of global semantic features of the picture modality may be realized by referring to the CLIP model above. For extraction of global semantic features of the audio modality, audio is converted to text, referring to the extraction of the global semantic features of the text modality.

In S206, the semantic coding features of the first data are acquired based on the semantic entity coding features of the first data, the global semantic features of the first data, and a preset weight ratio and by using a fusion module in the cross-modal feature extraction model.

Steps S204 to S206 are an implementation of step S103 of the embodiment shown in FIG. 1 above, which shows in detail the process of acquiring semantic coding features of information of modalities.

Firstly, in this embodiment, for the first data of the second modality, the semantic entity coding features of the first data are acquired based on the corresponding semantic entities, which are used as fine-grained feature information of the first data. Then, the global semantic features of the first data are acquired as overall feature information of the first data. Finally, the semantic entity coding features of the first data are fused with the global semantic features of the first data to supplement and enhance the global semantic features of the first data, so as to obtain the semantic coding features of the first data more accurately.

In this embodiment, during the fusion, the two can be fused based on the preset weight ratio. Specifically, the weight ratio may be set according to actual experience, such as 1:9, 2:8, or other, which is not limited herein. Since the global semantic features of the first data are more capable of representing the information of modalities as a whole, it may occupy a greater weight in the weight ratio. However, the semantic entity coding features as fine-grained information only serve as supplements and enhancements and may occupy a smaller weight in weight configuration.

In an embodiment of the present disclosure, when the cross-modal feature extraction model is trained, the training data used may include N modalities, where N is a positive integer greater than or equal to 2. The N modalities may be video, text, voice, and picture modalities, etc. Corresponding to the feature extraction, feature extraction of information of any modality in data including N modalities may be realized. The cross-modal feature extraction model has been capable of aligning information of different modalities in a feature space during the training, and the semantic coding features of the modalities represented have referred to the information of other modalities, so the accuracy of the semantic coding features of the modalities obtained is very high.

For example, in the cross-modal retrieval of video and text, corresponding video samples and text have a strong semantic correlation. For example, in a statement “An egg has been broken and dropped into the cup and water is boiling in the sauce pan”, noun entities such as egg, cup, water, and pan appear in the sentence, and verb entities such as drop and boiling appear at the same time. Since the text is a description of video content, entities such as egg and cup may also appear in the video content correspondingly. Intuitively, the entities should be capable of matching correspondingly. Based on this, in the technical solution of the present disclosure, a plurality of semantic entities of the two modalities of video and text can be extracted respectively, and respective semantic entity coding features can be obtained through independent coding modules, which can be integrated into the global semantic features of the video and the text to supplement the features and enhance the code, so as to obtain the semantic coding features with higher accuracy.

According to the method for feature extraction in cross-modal applications in this embodiment, in the above manner, semantic coding features of information of modalities can be acquired according to semantic entity coding features of the information of the modalities and global semantic features of the information of the modalities. The semantic entity coding features of the information of the modalities can represent fine-grained information of the information of the modalities, supplement and enhance the global semantic features, so as to make the accuracy of the extracted semantic coding features of the information of the modalities very high, thereby improving retrieval efficiency of retrieval performed based on the semantic coding features of the information of the modalities.

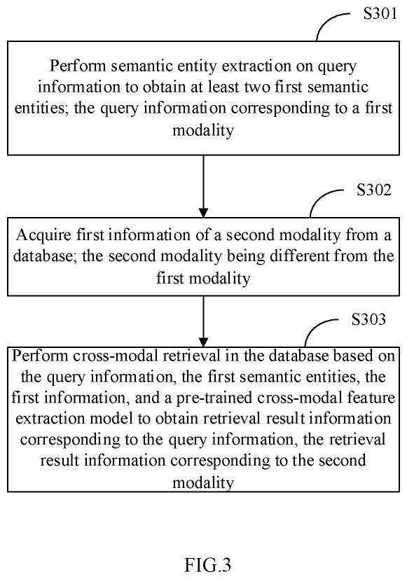

FIG. 3 is a schematic diagram according to a third embodiment of the present disclosure. As shown in FIG. 3, this embodiment provides a method for cross-modal retrieval, which may specifically include the following steps.

In S301, semantic entity extraction is performed on query information to obtain at least two first semantic entities; the query information corresponding to a first modality.

In S302, first information of a second modality is acquired from a database; the second modality being different from the first modality.

In S303, cross-modal retrieval is performed in the database based on the query information, the first semantic entities, the first information, and a pre-trained cross-modal feature extraction model to obtain retrieval result information corresponding to the query information, the retrieval result information corresponding to the second modality.

The method for cross-modal retrieval in this embodiment may be applied to a cross-modal retrieval system.

The cross-modal retrieval in this embodiment identifies that a modality of a query statement Query is different from that of the data in the database referenced during the retrieval. Certainly, a modality of the obtained retrieval result information may also be different from that of the Query.

For example, in the cross-modal retrieval based on video and text, the text may be retrieved based on the video, and the video may also be retrieved based on the text.

In the cross-modal retrieval in this embodiment, in order to improve retrieval efficiency, semantic entity information may also be considered. Specifically, firstly, semantic entity extraction is performed on query information to obtain at least two first semantic entities. Specifically, semantic entity extraction methods vary based on different modalities of the query information. The query information in this embodiment corresponds to the first modality. For example, the first modality may be a video modality or text modality, or a picture modality or audio modality. Specifically, refer to the extraction methods of the semantic entities of the corresponding types of modalities in the embodiment shown in FIG. 2 above for details, which are not described herein again.

Each piece of data in the database of this embodiment may include information of a plurality of modalities, such as video and text, so that the cross-modal retrieval based on video and text can be realized.

According to the method for cross-modal retrieval in this embodiment, the cross-modal retrieval in the database can be realized according to the query information, the corresponding at least two first semantic entities, the first information of the second modality of each piece of data in the database, and the pre-trained cross-modal feature extraction model, especially with reference to the semantic entity information, which can play a feature enhancement effect and can effectively improve the efficiency of the cross-modal retrieval.

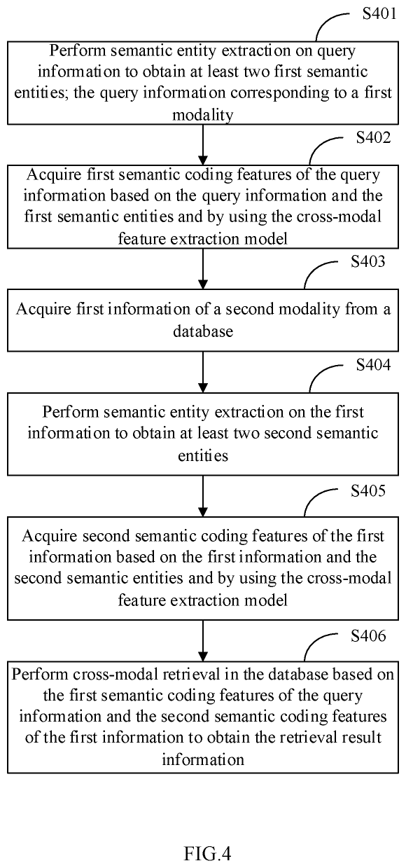

FIG. 4 is a schematic diagram according to a fourth embodiment of the present disclosure. As shown in FIG. 4, this embodiment provides a method for cross-modal retrieval, and describes the technical solution of the present disclosure in further detail on the basis of the technical solution in the embodiment shown in FIG. 3. As shown in FIG. 4, the method for cross-modal retrieval according to this embodiment may specifically include the following steps.

In S401, semantic entity extraction is performed on query information to obtain at least two first semantic entities; the query information corresponding to a first modality.

In S402, first semantic coding features of the query information are acquired based on the query information and the first semantic entities and by using the cross-modal feature extraction model.

For example, semantic entity coding features of the query information may be acquired based on at least two semantic entities of the query information and by using an entity coding module in the cross-modal feature extraction model. Moreover, global semantic features of information of the modality are acquired based on the query information and by using a global semantic feature extraction module in the cross-modal feature extraction model. First semantic coding features of the query information are acquired based on the semantic entity coding features of the query information, the global semantic features of the information of the modality, and a preset weight ratio and by using a fusion module in the cross-modal feature extraction model. In this manner, the accuracy of the semantic coding features of the query information can be further improved.

In S403, first information of a second modality is acquired from a database.

For example, the first information of the second modality of each piece of data in the database may be acquired.

In S404, semantic entity extraction is performed on the first information to obtain at least two second semantic entities.

In S405, second semantic coding features of the first information are acquired based on the first information and the second semantic entities and by using the cross-modal feature extraction model.

In the implementation, in the cross-modal retrieval, the semantic coding features of information of each modality of each piece of data in the database are acquired in real time through step S404 and step S405. For the semantic entity extraction performed on the first information of the second modality of each piece of data, specific extraction manners vary based on different modalities. For details, please refer to the relevant description in the embodiment shown in FIG. 2 above. Details are not described herein again.

In addition, optionally, in this embodiment, the semantic coding features of information of each modality of each piece of data in the database may also be acquired in advance and stored in the database. The semantic coding features may be directly acquired when used. For example, in specific implementation, second semantic coding feature of the first information of the second modality of each piece of data can be acquired directly from the database.

In this case, correspondingly, prior to acquiring second semantic coding feature of the first information of the second modality of each piece of data from the database, the method may further include the following steps:
(1) performing semantic entity extraction on the first information to obtain second semantic entities;
(2) acquiring second semantic coding features of the first information based on the first information and the second semantic entities and by using the cross-modal feature extraction model; and
(3) storing the second semantic coding features of the first information in the database.

Implementations of steps (1) and (2) may be obtained with reference to steps S404 to S405, and the only difference is that steps (1)-(3) are performed prior to the cross-modal retrieval. The second semantic coding features of the first information of the second modality of each piece of data can be stored in the database in advance and acquired directly when used, which can further shorten the retrieval time and improve the retrieval efficiency.

Certainly, in this manner, the semantic coding features corresponding to information of other modalities of each piece of data in the database can be acquired in advance and pre-stored. For example, the method may further include the following steps:
(4) acquiring second information corresponding to the first modality from the database;
(5) performing semantic entity extraction on the second information to obtain at least two third semantic entities;
(6) acquiring third semantic coding features of the second information based on the second information and the third semantic entities and by using the cross-modal feature extraction model; and
(7) storing the third semantic coding features of the second information in the database.

Steps (4)-(7) are performed prior to the cross-modal retrieval. The semantic coding features of the second information of the first modality of each piece of data can be stored in the database in advance and acquired directly when used, which can further shorten the retrieval time and improve the retrieval efficiency. If each piece of data in the database further includes information of other modalities, the processing manner is the same. Details are not described herein again.

When the second semantic coding features of the first information are acquired based on the first information and the second semantic entities and by using the cross-modal feature extraction model, semantic entities of the first information of the second modality may be extracted first based on the first information of the second modality, and semantic entity coding features of the first information of the second modality may be acquired by using an entity coding module in the cross-modal feature extraction model. Moreover, global semantic features of the first information of the second modality are acquired based on the first information of the second modality and by using a global semantic feature extraction module in the cross-modal feature extraction model. Second semantic coding features of the first information of the second modality are acquired based on the semantic entity coding features of the first information of the second modality, the global semantic features of the first information of the second modality, and a preset weight ratio and by using a fusion module in the cross-modal feature extraction model. In this manner, the accuracy of the semantic coding features of the first information of the second modality can be further improved. In this manner, second semantic coding features of the first information of the second modality of each piece of data in the database can be extracted.

In S406, cross-modal retrieval is performed in the database based on the first semantic coding features of the query information and the second semantic coding features of the first information to obtain the retrieval result information.

The second semantic coding feature of the first information may refer to the second semantic coding feature of the first information of the second modality of each piece of data in the database. Specifically, a similarity between the semantic coding features of the query information and the semantic coding features of the first information of the second modality in each piece of data may be calculated, and then retrieval results are screened based on the similarity, to obtain the retrieval result information. For example, based on the similarity, data corresponding to the second semantic coding features of first N pieces of first information with the highest similarity can be acquired as the retrieval result information, where N may be set as required, which may be 1 or a positive integer greater than 1.

According to the method for cross-modal retrieval in this embodiment, the cross-modal retrieval in the database can be realized according to the query information, the corresponding at least two first semantic entities, the first information of the second modality of each piece of data in the database, and the pre-trained cross-modal feature extraction model, especially with reference to the semantic entity information, which can play a feature enhancement effect and can effectively improve the efficiency of the cross-modal retrieval.

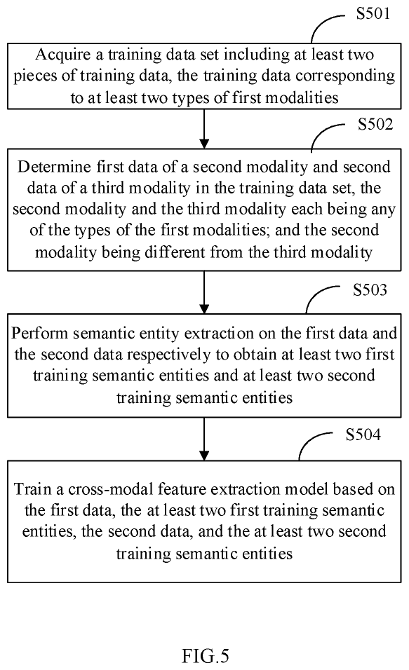

FIG. 5 is a schematic diagram according to a fifth embodiment of the present disclosure. As shown in FIG. 5, this embodiment provides a method for training a cross-modal feature extraction model, which may specifically include the following steps.

In S501, a training data set including at least two pieces of training data is acquired, the training data corresponding to at least two types of first modalities.

In S502, first data of a second modality and second data of a third modality are determined in the training data set, the second modality and the third modality each being any of the types of the first modalities; and the second modality being different from the third modality.

For example, specifically, the first data of the second modality and the second data of the third modality of each piece of training data in the training data set may be acquired.

In S503, semantic entity extraction is performed on the first data and the second data respectively to obtain at least two first training semantic entities and at least two second training semantic entities.

In S504, a cross-modal feature extraction model is trained based on the first data, the at least two first training semantic entities, the second data, and the at least two second training semantic entities.

The method for training a cross-modal feature extraction model in this embodiment is configured to train the cross-modal feature extraction model in the embodiment shown in FIG. 1 to FIG. 4.

In this embodiment, the training data may include information of more than two modalities. For example, in order to train a cross-modal feature extraction model based on video and text, corresponding training data is required to include data of a video modality and a text modality. In order to train a cross-modal feature extraction model of text and pictures, corresponding training data is required to include data of a text modality and a picture modality. In practical applications, feature extraction across three or more modalities may also be realized by using the cross-modal feature extraction model, and the principle is the same as that across two modalities. Details are not described herein.

According to the method for training a cross-modal feature extraction model in this embodiment, a plurality of corresponding training semantic entities are required to be extracted for data of modalities in the training data, and are combined with the data of the modalities in the training data to train the cross-modal feature extraction model together. Due to the addition of training semantic entities of information of the modalities, the cross-modal feature extraction model can pay attention to fine-grained information of the information of the modalities, which can further improve the accuracy of the cross-modal feature extraction model.

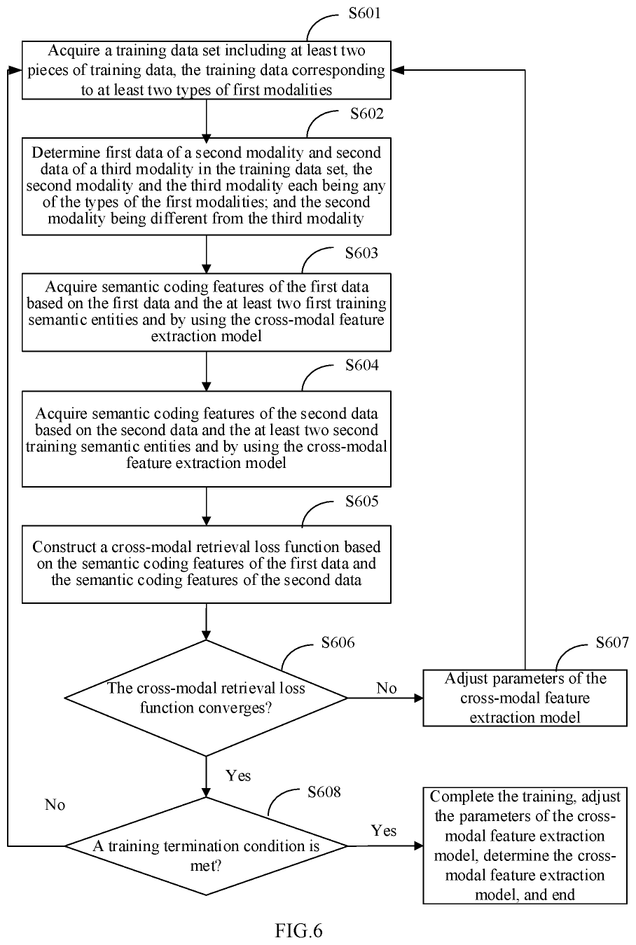

FIG. 6 is a schematic diagram according to a sixth embodiment of the present disclosure. As shown in FIG. 6, this embodiment provides a cross-modal feature extraction model method, and describes the technical solution of the present disclosure in further detail on the basis of the technical solution in the embodiment shown in FIG. 5. As shown in FIG. 6, the cross-modal feature extraction model method according to this embodiment may specifically include the following steps.

In S601, a training data set including at least two pieces of training data is acquired, the training data corresponding to at least two types of first modalities.

In S602, first data of a second modality and second data of a third modality are determined in the training data set, the second modality and the third modality each being any of the types of the first modalities; and the second modality being different from the third modality.

For example, specifically, the first data of the second modality and the second data of the third modality of each piece of training data in the training data set may be acquired.

In S603, semantic coding features of the first data are acquired based on the first data and the at least two first training semantic entities and by using the cross-modal feature extraction model.

In S604, semantic coding features of the second data are acquired based on the second data and the at least two second training semantic entities and by using the cross-modal feature extraction model.

For example, in this embodiment, semantic entity coding features of the first data are acquired based on the first data and the at least two first training semantic entities and by using an entity coding module in the cross-modal feature extraction model. Then, global semantic features of the first data are acquired based on the first data and by using a global semantic feature extraction module in the cross-modal feature extraction model. Finally, the semantic coding features of the first data are acquired based on the semantic entity coding features of the first data, the global semantic features of the first data, and a preset weight ratio and by using a fusion module in the cross-modal feature extraction model. Refer to the relevant description in the embodiment shown in FIG. 2 above for details. Details are not described herein again. Similarly, in the same manner, the semantic coding features of the second data can be acquired.

In S605, a cross-modal retrieval loss function is constructed based on the semantic coding features of the first data and the semantic coding features of the second data.

For example, the step may specifically include: constructing a first sub-loss function for information retrieval from the second modality to the third modality and a second sub-loss function for information retrieval from the third modality to the second modality respectively based on the semantic coding features of the first data and the semantic coding features of the second data; and adding the first sub-loss function and the second sub-loss function to obtain the cross-modal retrieval loss function. The cross-modal retrieval loss function is constructed based on all training data in the training data set. When the training data set includes more than two pieces of training data, all first sub-loss functions and all second sub-loss functions may be constructed based on the semantic coding features of the first data and the semantic coding features of the second data in each piece of training data; and all the first sub-loss functions are added, and all second sub-loss functions are also added. Finally, the sum of the added first sub-loss functions and the sum of the added second sub-loss functions are added together to obtain the cross-modal retrieval loss function.

In S606, it is detected whether the cross-modal retrieval loss function converges, and step S607 is performed if not; and step S608 is performed if yes.

In S607, parameters of the cross-modal feature extraction model are adjusted; and step S601 is performed to select next training data set to continue training.

In this embodiment, the parameters of the cross-modal feature extraction model are adjusted to converge the cross-modal retrieval loss function.

In S608, it is detected whether a training termination condition is met, if yes, the training is completed, the parameters of the cross-modal feature extraction model are adjusted, the cross-modal feature extraction model is then determined, and the process ends. If not, step S601 is performed to select next training data set to continue training.

The training termination condition in this embodiment may be a number of times of training reaching a preset number threshold. Alternatively, it is detected whether the cross-modal retrieval loss function converges all the time in a preset number of successive rounds of training, the training termination condition is met if convergence occurs all the time, and otherwise, the training termination condition is not met.

According to the method for training a cross-modal feature extraction model in this embodiment, the cross-modal feature extraction between any at least two modalities can be realized. For example, the extraction of the cross-modal feature extraction model based on video and text can be realized.

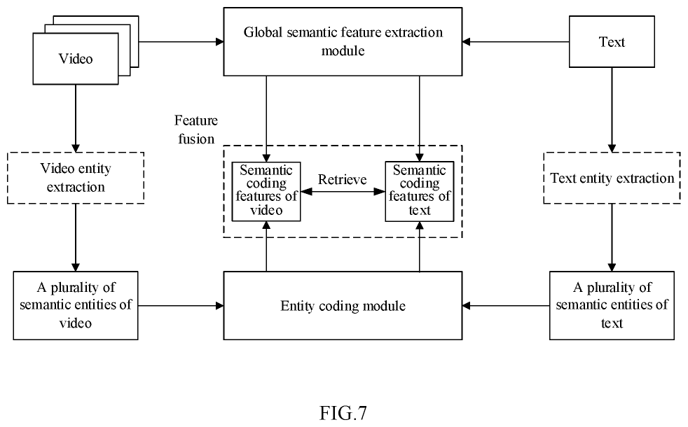

For example, based on the description of the above embodiment, for the training of the cross-modal feature extraction model based on video and text, a training architecture diagram of the cross-modal feature extraction model based on video and text as shown in FIG. 7 can be obtained. As shown in FIG. 7, a plurality of semantic entities of the video and a plurality of semantic entities of the text may be extracted respectively according to the description in the above embodiment.

For the video, semantic entity coding features of the video may be acquired by using an entity coding module in the cross-modal feature extraction model based on video and text. In specific implementation, firstly, coding features of the semantic entities and corresponding attention scores may be acquired based on the plurality of semantic entities of the video and by using the entity coding module in the cross-modal feature extraction model based on video and text. Then, the semantic entity coding features of the video are acquired based on the coding features of the semantic entities and the corresponding attention scores.

Similarly, for the text, semantic entity coding features of the text may also be acquired by using the entity coding module in the cross-modal feature extraction model based on video and text. In specific implementation, firstly, coding features of the semantic entities and corresponding attention scores may be acquired based on the plurality of semantic entities of the text and by using the entity coding module in the cross-modal feature extraction model based on video and text. Then, the semantic entity coding features of the text are acquired based on the coding features of the semantic entities and the corresponding attention scores.

In addition, global semantic features of the video and global semantic features of the text are further required to be acquired respectively by using a global semantic feature extraction model in the cross-modal feature extraction model based on video and text.

Then, for the video, the semantic coding features of the video are acquired based on the semantic entity coding features of the video, the global semantic features of the video, and a preset weight ratio and by using a fusion module in the cross-modal feature extraction model based on video and text. Then, for the text, the semantic coding features of the text are acquired based on the semantic entity coding features of the text, the global semantic features of the text, and a preset weight ratio and by using the fusion module in the cross-modal feature extraction model based on video and text.

During the training of the cross-modal feature extraction model based on video and text, a first sub-loss function for video-to-text retrieval and a second sub-loss function for text-to-video retrieval can be constructed; and vice versa. The cross-modal retrieval loss function is equal to the sum of the first sub-loss function and the second sub-loss function.

During the training in this embodiment, high-level semantic coding of the two modalities is constrained based on InfoNCE loss of contrastive learning, and calculation formulas thereof are as follows:

$$s ( {v}_{i} , {t}_{j} ) = \frac{{W}_{j}^{T} {\hat{z}}_{i}}{‖ {w}_{j} ‖ ‖ {\hat{z}}_{i} ‖} \qquad ( 4 )$$

$${L}_{v 2 t} = - \frac{1}{B} {\sum }_{i}^{B} log \frac{exp ( s ( {v}_{i} , {t}_{i} )}{{\sum }_{j = 1}^{B} exp ( s ( {v}_{i} , {t}_{j} ) )} \qquad ( 5 )$$

$${L}_{t 2 v} = - \frac{1}{B} {\sum }_{i}^{B} log \frac{exp ( s ( {v}_{i} , {t}_{i} )}{{\sum }_{j = 1}^{B} exp ( s ( {v}_{j} , {t}_{i} ) )} \qquad ( 6 )$$

$$L = {L}_{v 2 t} + {L}_{t 2 v} \qquad ( 7 )$$

wⱼ denotes a semantic coding feature of text tⱼ, \dot{\ddot{z}}ᵢ denotes a semantic coding feature of video vᵢ, a cosine similarity s(vᵢ, tⱼ) of coding of two modalities is calculated through the formula (4), Lᵥ₂ₜ denotes the first sub-loss function for video-to-text retrieval, and Lₜ₂ᵥ denotes the second sub-loss function for text-to-video retrieval. An overall loss function L is defined as being obtained by summing Lᵥ₂ₜ and Lₜ₂ᵥ through the formula (7).

According to the method for training a cross-modal feature extraction model in this embodiment, a plurality of corresponding training semantic entities are required to be extracted for information of modalities in the training data, and are combined with the information of the modalities in the training data to train the cross-modal feature extraction model together. Due to the addition of the training semantic entities of the information of the modalities, the cross-modal feature extraction model can pay attention to fine-grained information of the information of the modalities, which can further improve the accuracy of the cross-modal feature extraction model. Moreover, when the loss function can be constructed, relevant loss functions for the cross-modal retrieval can be constructed as supervision based on contrastive learning, which enable information of different modalities to be aligned in a semantic coding feature space, and can effectively improve accuracy of expression of semantic coding features of the information of the modalities by the cross-modal feature extraction model.

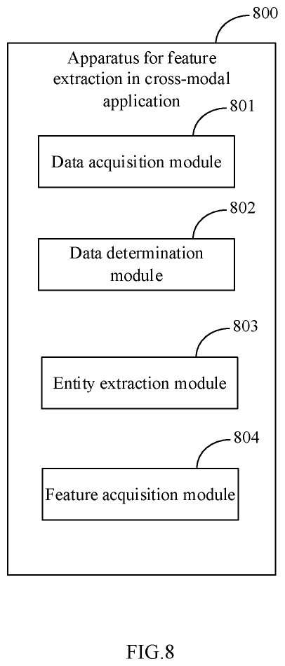

FIG. 8 is a schematic diagram according to a seventh embodiment of the present disclosure. As shown in FIG. 8, this embodiment provides an apparatus 800 for feature extraction in cross-modal applications, including a data acquisition module 801 configured to acquire to-be-processed data, the to-be-processed data corresponding to at least two types of first modalities; a data determination module 802 configured to determine first data of a second modality in the to-be-processed data, the second modality being any of the types of the first modalities; an entity extraction module 803 configured to perform semantic entity extraction on the first data to obtain semantic entities; and a feature acquisition module 804 configured to acquire semantic coding features of the first data based on the first data and the semantic entities and by using a pre-trained cross-modal feature extraction model.

An implementation principle and a technical effect of the apparatus 800 for feature extraction in cross-modal applications in this embodiment realizing feature extraction in the cross-modal applications by using the above modules are the same as those in the above related method embodiment. Details may be obtained with reference to the description in the above related method embodiment, and are not described herein.

Further optionally, in an embodiment of the present disclosure, the entity extraction module 803 is configured to the second modality being a video modality; extract the semantic entities of video frames in the first data by using a pre-trained semantic entity extraction model.

Further optionally, in an embodiment of the present disclosure, the entity extraction module 803 is configured to the second modality being a text modality; label semantic roles for terms in the first data; and acquire the semantic entities based on the semantic roles. Further optionally, in an embodiment of the present disclosure, the feature acquisition module 804 is configured to acquire semantic entity coding features of information of the modalities based on the plurality of semantic entities of the information of the modalities and by using an entity coding module in the cross-modal feature extraction model; acquire global semantic features of the information of the modalities based on the information of the modalities and by using a global semantic feature extraction module in the cross-modal feature extraction model; and acquire semantic coding features of the information of the modalities based on the semantic entity coding features of the information of the modalities, the global semantic features of the information of the modalities, and a preset weight ratio and by using a fusion module in the cross-modal feature extraction model, and acquire semantic entity coding features of the first data based on the semantic entities and by using the entity coding module in the cross-modal feature extraction model; acquire global semantic features of the first data based on the first data and by using the global semantic feature extraction module in the cross-modal feature extraction model; and acquire the semantic coding features of the first data based on the semantic entity coding features, the global semantic features, and a preset weight ratio and by using the fusion module in the cross-modal feature extraction model.

Further optionally, in an embodiment of the present disclosure, the feature acquisition module 804 is configured to acquire coding features of the semantic entities and corresponding attention information based on the semantic entities and by using the entity coding module; and acquire the semantic entity coding features of the first data based on the coding features of the semantic entities and the corresponding attention information.

An implementation principle and a technical effect of the apparatus 800 for feature extraction in cross-modal applications in the above embodiment realizing cross-modal feature extraction by using the above modules are the same as those in the above related method embodiment. Details may be obtained with reference to the description in the above related method embodiment, and are not described herein.

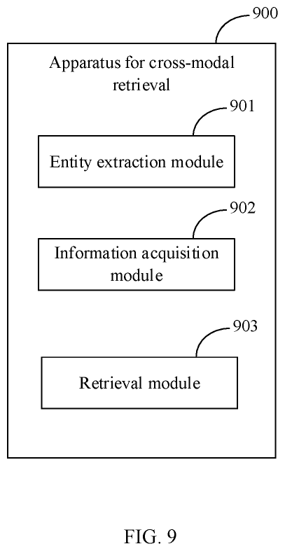

FIG. 9 is a schematic diagram according to an eighth embodiment of the present disclosure. As shown in FIG. 9, this embodiment provides an apparatus 900 for cross-modal retrieval, including an entity extraction module 901 configured to perform semantic entity extraction on query information to obtain at least two first semantic entities; the query information corresponding to a first modality; an information acquisition module 902 configured to acquire first information of a second modality from a database; the second modality being different from the first modality; and a retrieval module 903 configured to perform cross-modal retrieval in the database based on the query information, the first semantic entities, the first information, and a pre-trained cross-modal feature extraction model to obtain retrieval result information corresponding to the query information, the retrieval result information corresponding to the second modality.

An implementation principle and a technical effect of the apparatus 900 for cross-modal retrieval in this embodiment realizing cross-modal retrieval by using the above modules are the same as those in the above related method embodiment. Details may be obtained with reference to the description in the above related method embodiment, and are not described herein.

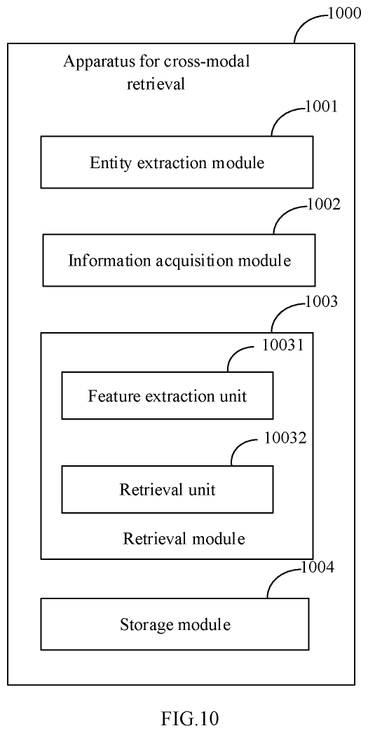

FIG. 10 is a schematic diagram according to a ninth embodiment of the present disclosure. As shown in FIG. 10, this embodiment provides an apparatus 1000 for cross-modal retrieval, including the modules with same names and same functions as shown in FIG. 9, i.e., an entity extraction module 1001, an information acquisition module 1002, and a retrieval module 1003.

As shown in FIG. 10, the retrieval module 1003 includes a feature extraction unit 10031 configured to acquire first semantic coding features of the query information based on the query information and the first semantic entities and by using the cross-modal feature extraction model; the feature extraction unit 10031 being further configured to acquire second semantic coding features of the first information; and a retrieval unit 10032 configured to perform cross-modal retrieval in the database based on the first semantic coding features and the second semantic coding features to obtain the retrieval result information.

Further optionally, in an embodiment of the present disclosure, the feature extraction unit 10031 is configured to perform semantic entity extraction on the first information to obtain at least two second semantic entities; and acquire the second semantic coding features based on the first information and the second semantic entities and by using the cross-modal feature extraction model.

Further optionally, in an embodiment of the present disclosure, the feature extraction unit 10031 is configured to acquire the second semantic coding features from the database.

Further optionally, as shown in FIG. 10, in an embodiment of the present disclosure, the apparatus 1000 for cross-modal retrieval further includes a storage module 1004.

The entity extraction module 1001 is further configured to perform semantic entity extraction on the first information to obtain the second semantic entities.

The feature extraction unit 10031 is further configured to acquire the second semantic coding features based on the first information and the second semantic entities and by using the cross-modal feature extraction model.

The storage module 1004 is configured to store the semantic coding features in the database.

Further optionally, in an embodiment of the present disclosure, the entity extraction module 1001 is further configured to acquire second information corresponding to the first modality from the database; perform semantic entity extraction on the second information to obtain at least two third semantic entities; and perform semantic entity extraction on information of the corresponding first modality for the data in the database, to obtain a plurality of third semantic entities.

The feature extraction unit 10031 is further configured to acquire third semantic coding features of the second information based on the second information and the third semantic entities and by using the cross-modal feature extraction model.

The storage module 1004 is configured to store the third semantic coding features in the database.

An implementation principle and a technical effect of the apparatus 1000 for cross-modal retrieval in this embodiment realizing cross-modal retrieval by using the above modules are the same as those in the above related method embodiment. Details may be obtained with reference to the description in the above related method embodiment, and are not described herein.

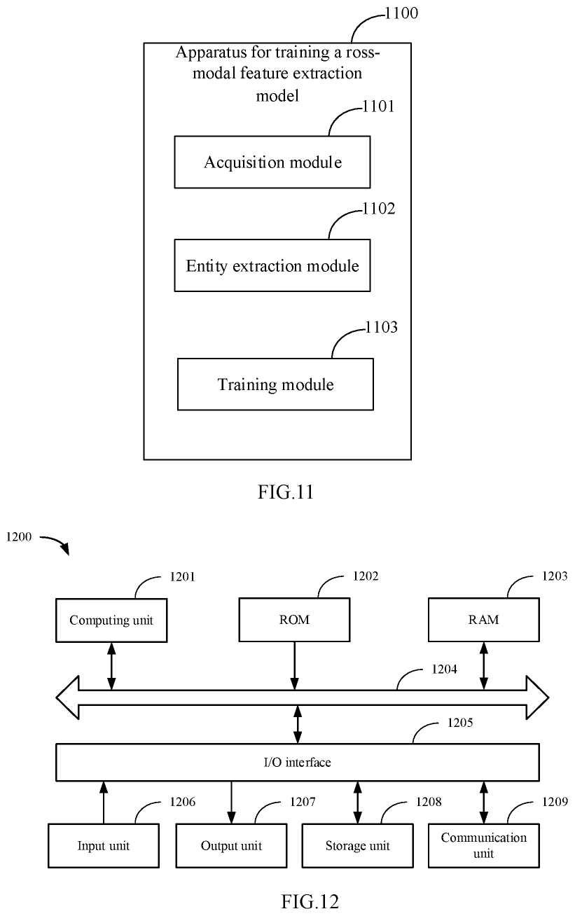

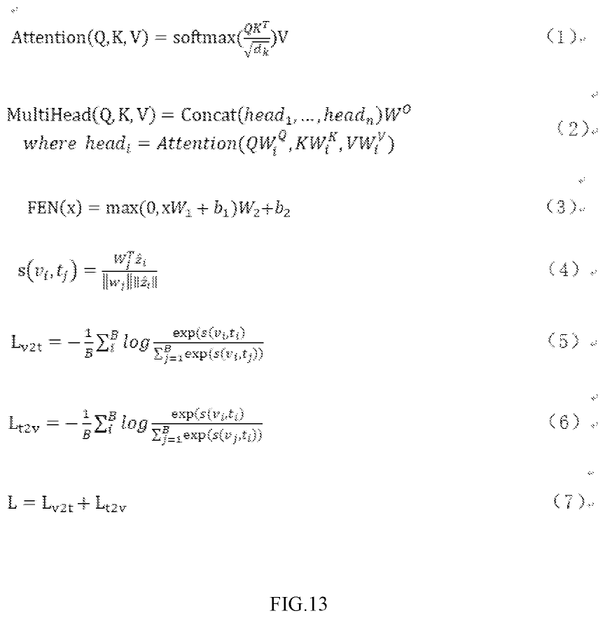

FIG. 11 is a schematic diagram according to a tenth embodiment of the present disclosure. As shown in FIG. 11, this embodiment provides an apparatus 1100 for training a cross-modal feature extraction model, including an acquisition module 1101 configured to acquire a training data set including at least two pieces of training data, the training data corresponding to at least two types of first modalities; an entity extraction module 1102 configured to perform semantic entity extraction on the first data and the second data respectively to obtain at least two first training semantic entities and at least two second training semantic entities; and a training module 1103 configured to train the cross-modal feature extraction model based on the first data, the at least two first training semantic entities, the second data, and the at least two second training semantic entities.

An implementation principle and a technical effect of the apparatus 1100 for training a cross-modal feature extraction model in this embodiment realizing cross-modal feature extraction model training by using the above modules are the same as those in the above related method embodiment. Details may be obtained with reference to the description in the above related method embodiment, and are not described herein.

Further optionally, in an embodiment of the present disclosure, the training module 1103 is configured to acquire semantic coding features of the first data based on the first data and the at least two first training semantic entities and by using the cross-modal feature extraction model; acquire semantic coding features of the second data based on the second data and the at least two second training semantic entities and by using the cross-modal feature extraction model; and construct a cross-modal retrieval loss function based on the semantic coding features of the first data and the semantic coding features of the second data.

Further optionally, in an embodiment of the present disclosure, the training module is configured to construct a first sub-loss function for information retrieval from the second modality to the third modality and a second sub-loss function for information retrieval from the third modality to the second modality respectively based on the semantic coding features of the first data and the semantic coding features of the second data; and add the first sub-loss function and the second sub-loss function to obtain the cross-modal retrieval loss function.

An implementation principle and a technical effect of the apparatus 1100 for training a cross-modal feature extraction model realizing cross-modal feature extraction model training by using the above modules are the same as those in the above related method embodiment. Details may be obtained with reference to the description in the above related method embodiment, and are not described herein.

Acquisition, storage, and application of users' personal information involved in the technical solutions of the present disclosure comply with relevant laws and regulations, and do not violate public order and moral.

According to embodiments of the present disclosure, the present disclosure further provides an electronic device, a readable storage medium, and a computer program product.

FIG. 12 is a schematic block diagram of an example electronic device 1200 that may be configured to implement an embodiment of the present disclosure. The electronic device is intended to represent various forms of digital computers, such as laptops, desktops, workbenches, PDAs, servers, blade servers, mainframe computers and other suitable computers. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 12, the device 1200 includes a computing unit 1201, which may perform various suitable actions and processing according to a computer program stored in a read-only memory (ROM) 1202 or a computer program loaded from a storage unit 1208 into a random access memory (RAM) 1203. The RAM 1203 may also store various programs and data required to operate the device 1200. The computing unit 1201, the ROM 1202, and the RAM 1203 are connected to one another by a bus 1204. An input/output (I/O) interface 1205 is also connected to the bus 1204.

A plurality of components in the device 1200 are connected to the I/O interface 1205, including an input unit 1206, such as a keyboard and a mouse; an output unit 1207, such as various displays and speakers; a storage unit 1208, such as disks and discs; and a communication unit 1209, such as a network card, a modem and a wireless communication transceiver. The communication unit 1209 allows the device 1200 to exchange information/data with other devices over computer networks such as the Internet and/or various telecommunications networks.

The computing unit 1201 may be a variety of general-purpose and/or special-purpose processing components with processing and computing capabilities. Some examples of the computing unit 1201 include, but are not limited to, a central processing unit (CPU), a graphics processing unit (GPU), various AI computing chips, various computing units that run machine learning model algorithms, a digital signal processor (DSP), and any appropriate processor, controller or microcontroller, etc. The computing unit 1201 performs the methods and processing described above, such as the method in the present disclosure. For example, in some embodiments, the method in the present disclosure may be implemented as a computer software program that is tangibly embodied in a machine-readable medium, such as the storage unit 1208. In some embodiments, part or all of a computer program may be loaded and/or installed on the device 1200 via the ROM 1202 and/or the communication unit 1209. One or more steps of the method in the present disclosure described above may be performed when the computer program is loaded into the RAM 1203 and executed by the computing unit 1201. Alternatively, in other embodiments, the computing unit 1201 may be configured to perform the method in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, the machine-readable medium may be tangible media which may include or store programs for use by or in conjunction with an instruction execution system, apparatus or device. The machine-readable medium may be a machine-readable signal medium or machine-readable storage medium. The machine-readable medium may include, but is not limited to, an electronic, magnetic, optical, electromagnetic, infrared, or semiconductor system, apparatus or device, or any suitable combinations thereof. More specific examples of a machine-readable storage medium may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the scope of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the scope of protection of the present disclosure.

What is claimed is:

1. A method for feature extraction in cross-modal applications, the method comprising:
acquiring to-be-processed data, the to-be-processed data corresponding to at least two types of first modalities;
determining first data of a second modality in the to-be-processed data, the second modality being any of the types of the first modalities;
performing semantic entity extraction on the first data to obtain semantic entities; and
acquiring semantic coding features of the first data based on the first data and the semantic entities and by using a pre-trained cross-modal feature extraction model.

2. The method according to claim 1, wherein the second modality is a video modality; and the performing semantic entity extraction on the first data to obtain semantic entities comprises:
extracting the semantic entities of video frames in the first data by using a pre-trained semantic entity extraction model.

3. The method according to claim 1, wherein the second modality is a text modality; and the performing semantic entity extraction on the first data to obtain semantic entities comprises:
labeling semantic roles for terms in the first data; and
acquiring the semantic entities based on the semantic roles.

4. The method according to claim 1, wherein the acquiring semantic coding features of the first data based on the first data and the semantic entities and by using a pre-trained cross-modal feature extraction model comprises:
acquiring semantic entity coding features of the first data based on the semantic entities and by using an entity coding module in the cross-modal feature extraction model;
acquiring global semantic features of the first data based on the first data and by using a global semantic feature extraction module in the cross-modal feature extraction model; and
acquiring the semantic coding features of the first data based on the semantic entity coding features, the global semantic features, and a preset weight ratio and by using a fusion module in the cross-modal feature extraction model.

5. The method according to claim 4, wherein, if at least two semantic entities are comprised, the acquiring semantic entity coding features of the first data based on the semantic entities and by using an entity coding module in the cross-modal feature extraction model comprises:
acquiring coding features of the semantic entities and corresponding attention information based on the semantic entities and by using the entity coding module; and
acquiring the semantic entity coding features of the first data based on the coding features of the semantic entities and the corresponding attention information.

6. A method for cross-modal retrieval, comprising:
performing semantic entity extraction on query information to obtain at least two first semantic entities; the query information corresponding to a first modality;
acquiring first information of a second modality from a database; the second modality being different from the first modality; and
performing cross-modal retrieval in the database based on the query information, the first semantic entities, the first information, and a pre-trained cross-modal feature extraction model to obtain retrieval result information corresponding to the query information, the retrieval result information corresponding to the second modality.

7. The method according to claim 6, wherein the performing cross-modal retrieval in the database based on the query information, the first semantic entities, the first information, and a pre-trained cross-modal feature extraction model to obtain retrieval result information corresponding to the query information comprises:
acquiring first semantic coding features of the query information based on the query information and the first semantic entities and by using the cross-modal feature extraction model;
acquiring second semantic coding features of the first information; and
performing cross-modal retrieval in the database based on the first semantic coding features and the second semantic coding features to obtain the retrieval result information.

8. The method according to claim 7, wherein the acquiring second semantic coding features of the first information comprises:
performing semantic entity extraction on the first information to obtain at least two second semantic entities; and
acquiring the second semantic coding features based on the first information and the second semantic entities and by using the cross-modal feature extraction model.

9. The method according to claim 7, wherein the acquiring second semantic coding features of the first information comprises:
acquiring the second semantic coding features from the database.

10. The method according to claim 9, wherein the method further comprises:
performing semantic entity extraction on the first information to obtain the second semantic entities;
acquiring the second semantic coding features based on the first information and the second semantic entities and by using the cross-modal feature extraction model; and
storing the semantic coding features in the database.

11. The method according to claim 10, wherein the method further comprises:
acquiring second information corresponding to the first modality from the database;
performing semantic entity extraction on the second information to obtain at least two third semantic entities;
acquiring third semantic coding features of the second information based on the second information and the third semantic entities and by using the cross-modal feature extraction model; and
storing the third semantic coding features in the database.

12. A method for training a cross-modal feature extraction model, comprising:
acquiring a training data set comprising at least two pieces of training data, the training data corresponding to at least two types of first modalities;
determining first data of a second modality and second data of a third modality in the training data set, the second modality and the third modality each being any of the types of the first modalities; and the second modality being different from the third modality;
performing semantic entity extraction on the first data and the second data respectively to obtain at least two first training semantic entities and at least two second training semantic entities; and
training a cross-modal feature extraction model based on the first data, the at least two first training semantic entities, the second data, and the at least two second training semantic entities.

13. The method according to claim 12, wherein the training the cross-modal feature extraction model based on the first data, the at least two first training semantic entities, the second data, and the at least two second training semantic entities comprises:
acquiring semantic coding features of the first data based on the first data and the at least two first training semantic entities and by using the cross-modal feature extraction model;
acquiring semantic coding features of the second data based on the second data and the at least two second training semantic entities and by using the cross-modal feature extraction model;
constructing a cross-modal retrieval loss function based on the semantic coding features of the first data and the semantic coding features of the second data; and
adjusting parameters of the cross-modal feature extraction model if the loss function does not converge.

14. The method according to claim 13, wherein the constructing a cross-modal retrieval loss function based on the semantic coding features of the first data and the semantic coding features of the second data comprises:
constructing a first sub-loss function for information retrieval from the second modality to the third modality and a second sub-loss function for information retrieval from the third modality to the second modality respectively based on the semantic coding features of the first data and the semantic coding features of the second data; and
adding the first sub-loss function and the second sub-loss function to obtain the cross-modal retrieval loss function.

15. An electronic device, comprising:
at least one processor; and
a memory communicatively connected with the at least one processor;
wherein the memory stores instructions executable by the at least one processor, and the instructions are executed by the at least one processor to enable the at least one processor to perform a method for feature extraction in cross-modal applications, wherein the method comprises:
acquiring to-be-processed data, the to-be-processed data corresponding to at least two types of first modalities;
determining first data of a second modality in the to-be-processed data, the second modality being any of the types of the first modalities;
performing semantic entity extraction on the first data to obtain semantic entities; and
acquiring semantic coding features of the first data based on the first data and the semantic entities and by using a pre-trained cross-modal feature extraction model.

16. The electronic device according to claim 15, wherein the second modality is a video modality; and the performing semantic entity extraction on the first data to obtain semantic entities comprises:
extracting the semantic entities of video frames in the first data by using a pre-trained semantic entity extraction model.

17. The electronic device according to claim 14, wherein the second modality is a text modality; and the performing semantic entity extraction on the first data to obtain semantic entities comprises:
labeling semantic roles for terms in the first data; and
acquiring the semantic entities based on the semantic roles.

18. The electronic device according to claim 15, wherein the acquiring semantic coding features of the first data based on the first data and the semantic entities and by using a pre-trained cross-modal feature extraction model comprises:
acquiring semantic entity coding features of the first data based on the semantic entities and by using an entity coding module in the cross-modal feature extraction model;
acquiring global semantic features of the first data based on the first data and by using a global semantic feature extraction module in the cross-modal feature extraction model; and
acquiring the semantic coding features of the first data based on the semantic entity coding features, the global semantic features, and a preset weight ratio and by using a fusion module in the cross-modal feature extraction model.

19. The electronic device according to claim 18, wherein, if at least two semantic entities are comprised, the acquiring semantic entity coding features of the first data based on the semantic entities and by using an entity coding module in the cross-modal feature extraction model comprises:
acquiring coding features of the semantic entities and corresponding attention information based on the semantic entities and by using the entity coding module; and
acquiring the semantic entity coding features of the first data based on the coding features of the semantic entities and the corresponding attention information.

20. A non-transitory computer readable storage medium with computer instructions stored thereon, wherein the computer instructions are used for causing a method for feature extraction in cross-modal applications, wherein the method comprises:
acquiring to-be-processed data, the to-be-processed data corresponding to at least two types of first modalities;
determining first data of a second modality in the to-be-processed data, the second modality being any of the types of the first modalities;
performing semantic entity extraction on the first data to obtain semantic entities; and
acquiring semantic coding features of the first data based on the first data and the semantic entities and by using a pre-trained cross-modal feature extraction model.
